(19) United States
(12) Patent Application Publication
(10) Pub. No.: US 2007/0239083 A1
(43) Pub. Date: Oct. 11, 2007

(54) Shock wave generators

(76) Inventor: Axel Voss, Kreuzlingen (CH)

Correspondence Address: ARNOLD & FERRERA, L.L.P., 2401 FOUNTAIN VIEW DRIVE, SUITE 630, HOUSTON, TX, 77057, US

(21) Appl. No.: 11/654,782

(22) Filed: Jan. 18, 2007

Related U.S. Application Data
(60) Provisional application No. 60/759,855, filed on Jan. 18, 2006.

(30) Foreign Application Priority Data
Jan. 18, 2006 (DE) 10 2006 002 418.4

(51) Int. Cl. A61H 1/00

(52) U.S. Cl. 601/4

(57) ABSTRACT

The invention relates to improvements for shock wave generators. The improvements relate on the one hand to a therapy head with a reflector and a reflector retainer, on the other hand to a field assistance device for a spark discharge section. A reflector according to the invention comprises two electrodes of a spark discharge section, wherein the reflector is made from cost-saving, corrosion-resistant, non-metallic materials, and a reflector retainer according to the invention comprises connection elements for connecting a reflector with a basis device, wherein the reflector can releasably be connected to and/or secured to the reflector retainer. The spark discharge section can be located next to a primary focus of the reflector ellipsoid to effect an extension of the target focus area. A field assistance device according to the invention for a spark discharge section is operating magnetically and allows reliable firing even for large distances of the electrodes.

### STATEMENT OF RELATED CASES

Pursuant to 35 U.S.C. 119(a), the instant application claims priority to prior German application number 10 2006 002 418.4, filed Jan. 18, 2006. This application also claims the benefit of U.S. Provisional Application No. 60/759,855, filed Jan. 18, 2006.

### FIELD OF THE INVENTION

The invention relates to improvements for shock wave generators.

### BACKGROUND

Shock wave generators are used in numerous medical fields. The best-known field is the therapeutic and cosmetic application in the treatment for instance of calculous diseases (e.g., urolithiasis, cholelithiasis) and the treatment of scars in human and veterinary medicine.

New fields of application relate to dental treatment, the treatment of arthrosis, the ablation of calcerous deposits (e.g., tendinosis calcarea), the treatment of chronic tennis or golfer elbows (so called radial or ulnar epicondylopathy), of chronic discomfort of the shoulder tendons (so called enthesopathy of the rotator cuff), and of chronic irritation of the Achilles tendon (so called achillodynia).

Furthermore, the generation of shock waves is used in the therapy of osteoporosis, periodontosis, non-healing bone fractures (so called pseudoarthrosis), bone necrosis, and similar diseases. Newer trials investigate the application in stem cell therapy.

Furthermore, the generation of shock waves can be used to exert mechanical stress, e.g., in the form of shearing forces, on cells, wherein their apoptosis is initiated. This happens for example by means of an initiation of the ‘death receptor pathway’ and/or the cytochrome c-pathway and/or a caspase cascade.

The term apoptosis is understood to refer to the initiation of a genetically controlled program, which leads to the ‘cell suicide’ of individual cells in the tissue structure. As a result, the cells concerned and their organoids shrink and disintegrate into fragments, the so-called apoptotic bodies. These are phagocytized afterwards by macrophages and/or adjoining cells. Consequently, the apoptosis constitutes a non-necrotic cell death without inflammatory reactions.

Therefore, the application of shock waves is beneficial in all cases, where it relates to the treatment of diseases with an abased rate of apoptosis, e.g. treatment of tumors or viral diseases.

Additionally, the generation of shock waves can be applied beneficially in the treatment of necrotically changed areas or structures in muscle tissue, especially in tissue of the cardiac muscle, in the stimulation of cartilage assembly in arthritic joint diseases, in the initiation of the differentiation of embryonic or adult stem cells in vivo and in vitro in relation to the surrounding cell structure, in the treatment of tissue weakness, especially of cellulitis, and in the degradation of adipose cells, as well as the activation of growth factors, especially TGF-[beta].

Likewise, the generation of shock waves can be used for avoiding the formation and/or extension of edema, for degradation of edema, for the treatment of ischaemia, rheumatism, diseases of joints, jaw bone (periodontosis), cardiologic diseases and myocardial infarcts, pareses (paralyses), neuritis, paraplegia, arthrosis, arthritis, for the prevention of scar formation, for the treatment of scar formation respectively nerve scarring, for the treatment of achillobursitis and other bone necroses.

Another application relates to the treatment of spinal cord and nerve lesions, for example spinal cord lesions accompanied by the formation of edema.

Shock waves are also applicable for the treatment of scarred tendon and ligament tissue as well as badly healing open wounds.

Such badly healing open wounds and boils are called ulcus or also ulceration. They are a destruction of the surface by tissue disintegration at the dermis and/or mucosa. Depending on what tissue fractions are affected, surfacial lesions are called exfoliation (only epidermis affected) or excoriation (epidermis and corium affected).

Open wounds that can be treated with shock waves comprise especially chronic leg ulcers, hypertensive ischaemic ulcers, varicose ulcers or ulcus terebrans due to a thereby caused improved healing process.

Furthermore, shock waves are suitable for the stimulation of cell proliferation and the differentiation of stem cells.

Typical shock wave generators comprise a basis device, to which a therapy head can be connected. The therapy head comprises an integrated reflector with a shock wave source and a coupling membrane.

The therapy head can be made from different materials and must comply with further safety requirement depending on the type of shock source.

The therapy head comprises a connection cable for connecting to a basis device. For the user, the therapy head represents a single unit.

Typically, the therapy heads at the devices are changeable, on the one hand to be able to attach different therapy heads or to be able to detach the therapy head for maintenance or refurbishing work.

Furthermore, shock wave generators often have a evaluation unit, which counts the number of shocks applied with a therapy head based on the interaction of basis device and therapy head.

This function usually is implemented by means of small chip units which are similar to chip card systems (telephone chip, SIM card, smart card, RFID chip).

For example, the plugs of the therapy head comprise a small counting unit in the connector, which counts up or down at each shock. The basis device can read the number from the counting unit. Thereby, the number of remaining shocks can easily be determined for each therapy head.

The reflector, which is integrated in the therapy head, is at least partially filled with a liquid. The liquid usually comprises a wave impedance corresponding approximately to the wave impedance of the body to be treated. Thereby, an easy coupling of the shock wave into the target object is made possible and losses during the coupling are minimized.

For filling the reflector with liquid or for emptying the liquid the therapy head can comprise valves.

The shock source is typically located in a focus or relatively near to a focus of the reflector.

The shock source is connected to the basis device by a suitable connection via the reflector retainer. The basis device supplies the treatment head with the necessary energy. Depending on the device, the basis device is also counting the number of shocks.

For example, the shock source is a spark discharge section.

Spark discharge systems comprise so called catalyzer material in their filling which is intended to reduce the bubbles generated during the spark discharge. For example, the catalyzer material can comprise palladium oxide hydrate that can bind hydrogen generated by re-hydrogenation or permeated hydrogen. Since catalyzer materials predominantly are based on noble metals, they are extremely expensive.

The reflector usually is made from stainless steel materials or brass alloys to minimize corrosion of the reflector surface and, at the same time, to have a material as dense as possible at one's disposal, which, at the same time, reflects sound waves.

Many new fields of application have in common that only a small number of shock waves is applied during each therapy session.

Typically, the therapy heads only have a reduced usage period, since the therapy head is worn out during storage as well as during usage.

Wearout by storage is promoted for example by diffusion through seals, coupling membrane, or valves. The consequence of this is that the reflector wall is getting rough by corrosion.

Furthermore, the so called “catalyzer” material is depleted.

However, especially in small medical practices, the number of patients is too small to be used economically reasonable within the usage period.

Also, time consuming reconditioning/refurbishing of the therapy heads is a disadvantage, since the whole therapy head must be sent in and thus long downtimes occur.

### SUMMARY OF THE INVENTION

It is therefore the object of the invention to provide an alternative which is cost-saving as well as user-friendly.

The object is solved by a therapy head according to the invention. The therapy head comprises a reflector retainer and a changeable reflector.

The reflector retainer comprises a retainer for the changeable reflector and a connecting cable to a basis device.

Furthermore, the reflector is made from ecologically friendly and cost-saving materials.

The connection cable or the reflector retainer or the reflector comprises an electronic code, which is readable from the basis device.

The invention also relates to a reflector, which is rotationally symmetrical with respect to an axis and which has an ellipsoidal or a paraboloidal form, and the spark discharge section of which is located outside of a primary focus of the ellipsoid, for example between 1 mm and 10 mm next to the primary focus.

Since shock waves which are generated at the primary focus (i.e., at the first focus) of the ellipsoid are focused at the target focus (i.e., the second focus), it is thus possible to let the focus area of the target focus become diffuse or to distort the focus image. Thus, an extension or enlargement of the focus area is achieved.

To generate shock waves by means of a spark discharge section an electrical breakdown is achieved by applying a high voltage to the electrodes. Here, firing is a function of the distance of the electrodes and of the applied high voltage.

A distance of the electrodes which is high as possible is desirable, since it leads to an increased lifetime of the electrodes, promotes a high steepness of the pressure increase of the shock wave, and leads to small leakage currents, thus increasing the efficiency factor.

However, an increasing distance of the electrodes leads to increasing statistical variations of the firing and to reliable firing getting more and more unlikely. These variations are also called latency. With increasing distance of the electrodes the latency time between applying the high voltage and firing increases, until firing ceases.

In the past, systems comprising polarizable particles or additional (auxiliary) electrodes have been proposed, to be able to implement a high distance of the electrodes.

On the one hand, construction and control of these systems is complicated, on the other hand, the distribution of the particles in the system and especially next to the electrodes must be ensured. Hereby, additional parts and/or auxiliary substances in the liquid are necessary, like for example substances for changing the pseudoplasticity.

It is therefore a further object of the invention to provide a spark discharge section by means of which a large distance of the electrodes is facilitated without the need for auxiliary substances or auxiliary electrodes.

The object is solved by a spark discharge section according to the invention. The spark discharge section comprises a field assistance device.

The field assistance device is based on a magnetic effect on the liquid.

### BRIEF DESCRIPTION OF THE DRAWINGS

In the following, the invention will be explained in detail with regard to the drawings.

FIG. 1 shows a schematic view of a therapy head according to the invention with a reflector retainer according to the invention and a reflector according to the invention.

FIG. 2 shows a schematic view of a therapy head according to the invention with a reflector retainer according to the invention and a reflector according to the invention, wherein the spark discharge section is located next to a primary focus of the reflector.

FIG. 3a shows a schematic view of a spark discharge section according to the invention with a field assistance device according to the invention.

FIG. 3b shows a schematic view of an alternative embodiment of a spark discharge section according to the invention with a field assistance device according to the invention.

FIG. 3c shows a schematic view of a further alternative embodiment of a spark discharge section according to the invention with a field assistance device according to the invention.

FIG. 3d shows a schematic detail view of an embodiment of an electrode of a spark discharge section according to the invention with a field assistance device according to the invention.

### DETAILED DESCRIPTION OF THE INVENTION

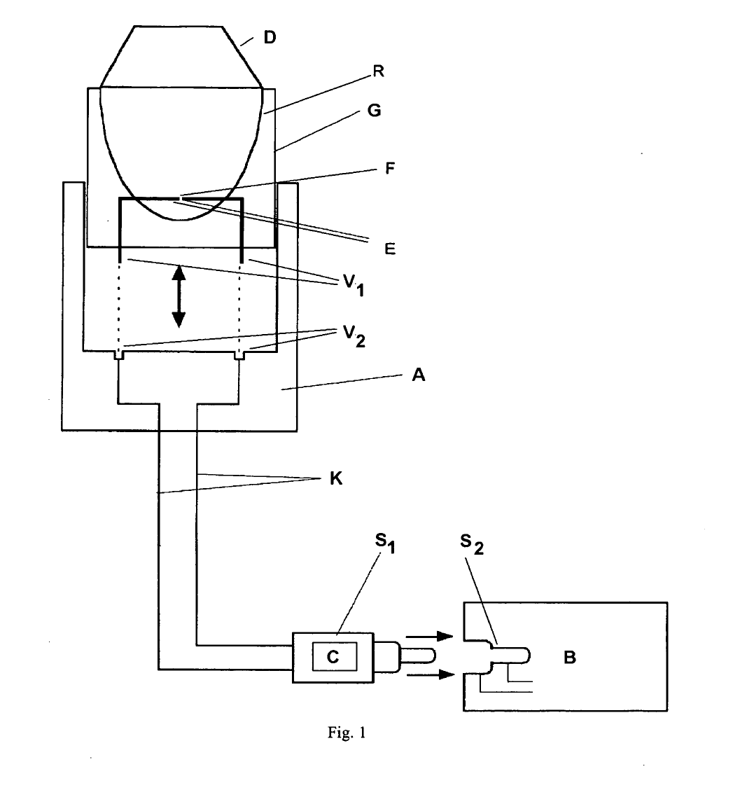

From the view according to FIG. 1, a schematic view of a therapy head according to the invention with a reflector retainer A according to the invention and a reflector R according to the invention can be seen.

The reflector R comprises two electrodes E of the spark discharge section F. Preferably, the electrodes are made from a stainless steel material. The reflector R is arranged in a housing G. The electrodes E are connected with connection elements V₁. The connection elements V₁ are arranged such that they are connectable to connection elements V₂ of a reflector retainer A.

Corresponding to the connection elements V₁ of the electrodes E, the reflector retainer A comprises connection elements V₂. The connection elements V₂ are connected to the basis device B by means of high voltage cables K. For example, the connection elements V₁ and V₂ can be implemented as a plug system or a rotation/plug system.

The connection elements V₁ and V₂ can also each comprise a safeguard, such that inadvertently touching the high voltage connection is prevented.

Moreover, the housing G can releasably be connected to and/or secured to the reflector retainer A. For example, the connection can be implemented as a bayonet coupling.

By implementing the reflector and the reflector retainer as releasably connectable by the user, it is easily possible to re-use therapy heads as soon as possible, since only the reflector must be changed and since not, as hitherto, the whole therapy head must be sent in for refurbishing.

The connection to the basis device B via high voltage cable K can be fixed or releasable, such that new devices as well as old devices can be equipped with a reflector retainer according to the invention.

In case of a releasable connection with the basis device B via high voltage cable K, a plug-and-socket connection S₁, S₂ can be provided, which is shown as an example in FIG. 1 as plug S₁ and socket S₂. Alternatively, different plug systems or rotation/plug systems are also possible.

Furthermore, the reflector is closed by a closure cap D. This closure cap D can be made from each material guaranteeing a good coupling, e.g. from silicone.

Furthermore, the reflector R is made from cost-saving, corrosion-resistant, non-metallic materials.

Such materials comprise ceramics and in particular porcelain.

In this case, the electrodes E can be integrated into the ceramic during firing, such that they are held securely without the need for additional parts.

Alternatively, the reflector R can be made from plastics, in particular from polyurethane. Meanwhile, most of such materials can be recycled.

In this case, the electrodes E can be inserted during manufacturing, e.g. during injection molding, such that they are held securely without the need for additional parts.

Furthermore, the closure cap D can be attached to the reflector R by means of a suitable glue in both cases.

In particular, reference is made to using a silicone-based glue that also allows gluing of the closure cap D to the reflector R in a liquid, for example during filling the reflector with liquid.

Furthermore, an expensive catalyzer is not necessary in such an assembly, since generated gases cannot lead to a large-area shielding of the shock waves during the lifetime of a reflector based on ceramic or plastics having a limited lifetime.

Since the reflector is made only from inert or recyclable materials, it can be disposed of after usage without problems.

The connection cable K or the plug S₁ or the reflector retainer A or the reflector R comprises an electronic code that can be read by the basis device.

This code is usually read by the basis device to display how many shock can still be applied with a therapy head.

Here, the electronic code can be integrated into the reflector retainer, into the reflector, or into the connection cable, especially into a plug S₁.

The electronic code is implemented by means of a small chip unit C, which is similar to a chip card system (telephone chip, SIM card, smart card, RFID chip). Besides the number of remaining shocks, the chip unit C can also store a serial number, the head type, error codes, therapy data, and further data.

Thus, therapeutic possibilities by means of shock waves become economically reasonable for small medical practices where hitherto the number of patients has been too small.

One or more substances inhibiting the formation of large gas bubbles by absorbing or bringing to reaction the gases (hydrogen and oxygen) created during the generation of shock waves can be in the reflector, which is filled with a medium (usually with water). Besides of or in addition to the palladium compounds mentioned above strong oxidizing and reducing agents can be used, like for example metal crystallites and/or water catalytes. Preferably, the used substances are water soluble and/or are present as a fine powder.

Furthermore, the medium can contain conducting, semiconducting, or polarizable substances or particles, facilitating the formation of a spark discharge between the electrodes E or, above a specific distance of the electrodes E, make it possible at all. These substances or particles can comprise a diameter from a few microns up to a few hundred microns, preferably 50 μm to 500 μm, and preferably form a colloidal suspension with the medium. Preferably, these particles are metallic, e.g. aluminum.

The schematic view in FIG. 2 shows a reflector according to the present invention, which can be used for the generation of shock waves. The reflector comprises two electrodes of the spark discharge section F. The electrodes preferably are made from a stainless steel material. The reflector R is arranged in a housing G. The electrodes E are connected with connection elements V₁. The connection elements V₁ are arranged such that they are connectable with connection elements V₂ of a reflector retainer A.

The reflector is closed with a closure cap D. The closure cap D can be made from each material guaranteeing a good coupling, e.g. from silicone. The closure cap D can be attached to the reflector R by means of a suitable glue, which allows gluing the closure cap D to the reflector R also in a liquid, for example during filling the reflector with a liquid.

The reflector R usually is rotationally symmetrical with respect to an axis and has an ellipsoidal form. Contrary to the embodiment from FIG. 1 explained above, where the spark discharge section F is located at a primary focus PF of the ellipsoid, whereby the shock waves are focused essentially in a target focus of the ellipsoid, the spark discharge section F here is located outside of the primary focus PF of the ellipsoid, making it possible to let the focus area of the target focus become diffuse or to distort the focus image. Thereby, an extension or enlargement of the focus area is achieved.

In a preferred embodiment, the spark discharge section F is located between 1 mm and 10 mm next to the primary focus PF. In a further preferred embodiment, the distance between the spark discharge section F and the primary focus PF of the reflector R is adjustable by the user, to allow a changeable size of the target focus area, into which the shock waves are focused by the reflector R. This adjustment can preferably be done externally, i.e. without the need to open the reflector.

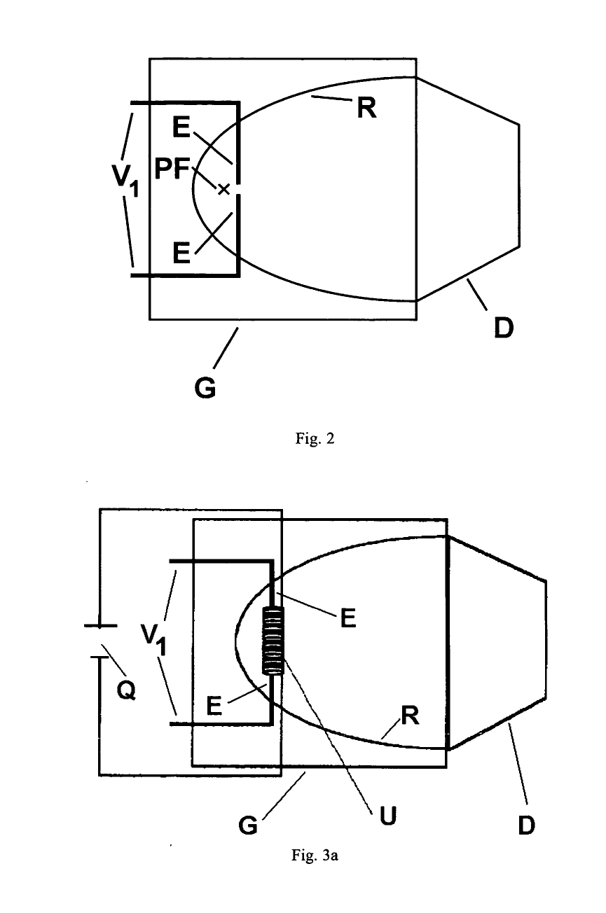

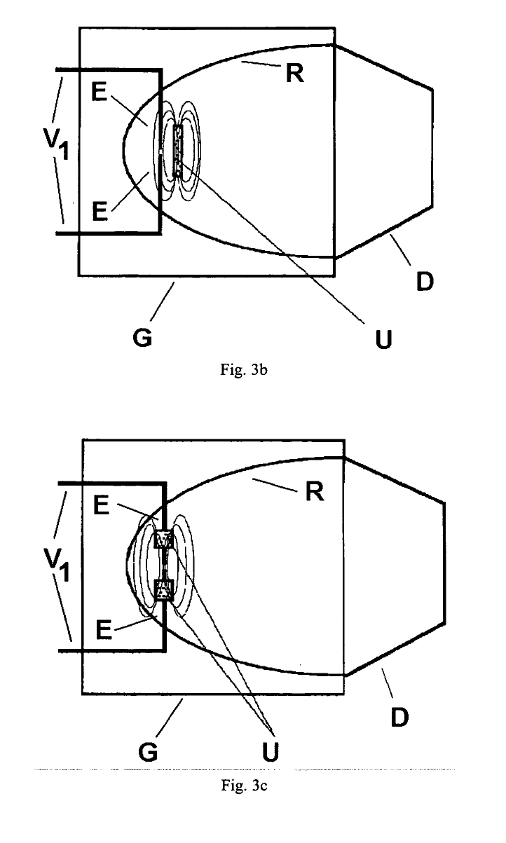

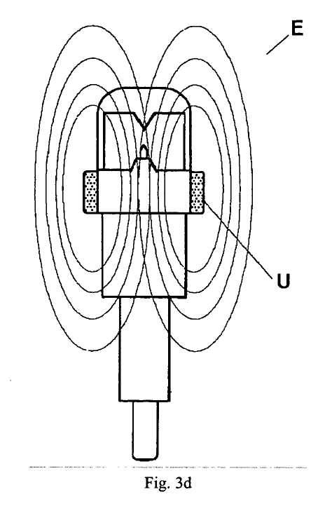

From the view according to FIG. 3a a schematic view of a spark discharge section according to the invention with a field assistance device U according to the invention can be seen.

The field assistance device U can provide a magnetic field that is aligned such that the main component of the magnetic field in the area of the spark discharge section F runs parallel to the spark discharge section F.

The reflector R is filled with a diamagnetic medium.

Materials which tend to leave a magnetic field or where the field line density of a magnetic field applied externally is reduced in the sample are called diamagnetic.

For example, if the reflector R is filled with water having a molar susceptibility at room temperature or with paraffins having for example a molar susceptibility (n-pentane) or (hexadecane) at room temperature, an external magnetic field can act on the medium due to the diamagnetic property.

Due to this action, reliable firing can be ensured even for a large distance of the electrodes E of the spark discharge section F.

The field assistance device U can be implemented as a coil located in the neighborhood of the spark discharge section F, as shown in FIG. 3a.

The coil is supplied by a schematically shown voltage source Q. For example, the voltage source Q can be integrated into the basis device B. The connection can then run for example in parallel to the high voltage cables K. The connection to the voltage source Q can be implemented pluggable in the basis device, like the high voltage cables K.

Furthermore, it is possible to implement the connection in a common plug-and-socket system S₁ and S₂ for the high voltage as well as for the voltage source Q.

Alternatively, the field assistance device U can be implemented by appropriately arranged permanent magnets, as shown in FIGS. 3b, 3c, and 3d.

Here it is only essential, that the magnetic field in the area of the spark discharge section runs essentially parallel to the spark discharge section.

Furthermore, the field assistance device U can be implemented in two parts, as shown in FIG. 3c, i.e. two coils or magnets can be used, the magnetic fields of which are aligned in the same direction, such that the magnetic field in the area of the spark discharge section F runs essentially parallel to the spark discharge section.

For example, a magnetic torus U can be applied to an electrode by means of an isolation, as shown in FIG. 3d. In the same manner, a coil U can be applied to an electrode by means of an isolation.

The isolation can for example also be made from cost-saving, corrosion-resistant, non-metallic materials.

Such materials comprise ceramics and in particular porcelain.

In this case, the isolation on the electrode E or on the electrodes E can be integrated into the ceramic during firing, such that they are held securely without the need for additional parts.

Alternatively, the isolation on the electrode E or on the electrodes E can be made from plastics, in particular from polyurethane. Meanwhile, most of such materials can be recycled.

In this case, the electrodes E or on the electrodes E can be inserted during manufacturing, e.g. during injection molding, such that they are held securely without the need for additional parts.

The field assistance device U according to the invention allows a high distance of the electrodes E and thus an increased lifetime of the electrodes E. Furthermore, a high steepness of the pressure increase of the shock wave is promoted and the efficiency factor is increased, since only small leakage currents occur.

Furthermore, by suitably forming the magnets it is possible to form the shock wave, for example by superposing a suction portion following the shock wave by reflection on the magnet. This can for example be achieved be a suitable arrangement behind the focus.

Contrary to hitherto known systems, the field assistance allows an uncomplicated construction and auxiliary substances are not needed.

Of course, the improvements explained above can be implemented in one device. The reflector R then comprises a field assistance device U. An isolation which might be necessary for attaching magnets or coils U can be produced simultaneously when producing the reflector R, such that production steps for a separate production can be saved.

### LIST OF REFERENCE SIGNS

A reflector retainer
B basis device
C chip unit
D closure cap
E electrode
F spark discharge section
G housing
K high voltage cable
Q voltage source
PF primary focus
R reflector
S₁ plug
S₂ socket
V₁ high voltage plug
V₂ high voltage socket

1. A reflector for a shock wave generator with two electrodes of a spark discharge section, wherein the reflector is built from a cost-saving, corrosion-resistant, non-metallic material.

2. The reflector according to claim 1, wherein the reflector is made from a ceramic.

3. The reflector according to claim 1, wherein the reflector is made from porcelain.

4. The reflector according to claim 1, wherein the reflector is made from plastics.

5. The reflector according to claim 1, wherein the reflector is made from polyurethane.

6. A reflector for a shock wave generator with two electrodes of a spark discharge section, wherein the reflector at least partially has an ellipsoidal or a paraboloidal form, and wherein the spark discharge section is located next to a primary focus of the reflector.

7. The reflector according to claim 6, wherein the distance from the spark discharge section to the primary focus of the reflector is between 1 mm and 10 mm.

8. The reflector according to claim 6, wherein the distance from the spark discharge section to the primary focus of the reflector is adjustable by the user.

9. The reflector according to claim 1, wherein the reflector comprises a code.

10. The reflector according to claim 9, wherein the reflector comprises a chip unit for storing the code.

11. The reflector according to claim 10, wherein the chip unit is a RFID chip.

12. The reflector according to claim 1, wherein the reflector is filled with a medium comprising at least one substance inhibiting the formation of large gas bubbles.

13. The reflector according to claim 12, wherein the at least one substance inhibiting the formation of large gas bubbles comprises metal crystallites and/or water catalytes.

14. The reflector according to claim 12, wherein the at least one substance inhibiting the formation of large gas bubbles is water soluble.

15. The reflector according to claim 12, wherein the at least one substance inhibiting the formation of large gas bubbles is present as a fine powder.

16. The reflector according to claim 1, wherein the reflector is filled with a medium comprising conducting, semiconducting, or polarizable substances or particles.

17. The reflector according to claim 16, wherein the conducting, semiconducting, or polarizable substances or particles form a colloidal suspension with the medium.

18. A reflector retainer for a shock wave generator comprising connection elements for connecting a reflector with a basis device, wherein the reflector can releasably be connected to and/or secured to the reflector retainer.

19. The reflector retainer according to claim 18, wherein the reflector retainer comprises high voltage cables.

20. The reflector retainer according to claim 18, wherein the reflector retainer further comprises a releasable connection device for connecting to the basis device.

21. The reflector retainer according to claim 20, wherein the releasable connection device comprises a code.

22. The reflector retainer according to claim 20, wherein the releasable connection device comprises a chip unit for the code.

23. The reflector retainer according to claim 22, wherein the chip unit is a RFID chip.

24. A field assistance device for a spark discharge section, wherein the field assistance device operates magnetically.

25. The field assistance device according to claim 24, wherein the field assistance device comprises a coil.

26. The field assistance device according to claim 24, wherein the field assistance device comprises a magnet.

27. The field assistance device according to claim 24, wherein the field assistance device is arranged such that the field assistance device provides a magnetic field that is aligned such that the main component of the magnetic field in the area of the spark discharge section runs parallel to the spark discharge section.

28. The field assistance device according to claim 24, wherein the field assistance device is constructed in two parts.
